(19) United States
(12) Patent Application Publication
(10) Pub. No.: US 2025/0071605 A1
(43) Pub. Date: Feb. 27, 2025

(54) METHOD, APPARATUS AND COMPUTER PROGRAM RELATING TO A QUALITY OF SERVICE FLOW

(71) Applicant: NOKIA TECHNOLOGIES OY, Espoo (FI)

(72) Inventors: Colin KAHN, Morris Plains, NJ (US); Devaki CHANDRAMOULI, Plano, TX (US); Fernando SANCHEZ MOYA, Wroclaw (PL)

(21) Appl. No.: 18/802,524

(22) Filed: Aug. 13, 2024

(30) Foreign Application Priority Data
Aug. 21, 2023 (GB) 2312728.5

(51) Int. Cl. H04W 28/02

(52) U.S. Cl. CPC H04W 28/0268

(57) ABSTRACT

A technique, comprising: receiving at a node of a radio access network of a mobile communication system one or more control plane messages indicating a plurality of quality-of-service profiles for a quality-of-service flow for a logical connection between a user equipment and a data network via the radio access network; receiving user plane messages for the quality-of-service flow at the radio access network node, wherein an individual user plane message comprises a header comprising at least a first field; determining at the radio access network node one of the plurality of quality-of-service profiles to adopt for the quality-of-service flow based on the first field and an indication in the one or more control plane messages of a mapping of the plurality of quality-of service profiles to a plurality of values for the first field.

### CROSS REFERENCE TO RELATED APPLICATION

This application claims the benefit of United Kingdom Patent Application No. 2312728.5, filed Aug. 21, 2023. The entire content of the above-referenced application is hereby incorporated by reference.

### TECHNICAL FIELD

Various example embodiments of this subject disclosure relate to methods, apparatuses, and computer programs, and in particular (but not exclusively) to methods, apparatuses, and computer programs relating to a quality-of-service (QOS) flow for a logical connection between a user equipment and a data network via the radio access network.

### BACKGROUND

A communication system can be seen as a facility that enables communication sessions between two or more entities, such as user terminals, base stations and/or other nodes by providing carriers between the various entities involved in the communications path. A communication system can be provided, for example, by means of a communication network and one or more compatible communication devices. The communication sessions may comprise, for example, communication of data for carrying communications such as voice, video, electronic mail (email), text message, multimedia and/or content data and so on. Non-limiting and illustrative examples of services provided comprise two-way or multi-way calls, data communication or multimedia services and access to a data network system, such as the Internet.

In a wireless communication system, at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

Various example embodiments of the subject disclosure aim at addressing at least part of the issue and/or problems and drawbacks either explicitly described herein or those otherwise apparent to a person skilled in the relevant arts to provide methods, apparatus and computer programs by which mechanisms and/or procedures relating to a quality-of-service (QOS) flow for a logical connection between a user equipment and a data network via the radio access network can be improved.

Various example embodiments of the subject disclosure will be described with respect to certain aspects. These aspects are not intended to indicate key or essential features of the various example embodiments, nor are they intended to be used to otherwise limit the scope of the subject disclosure. Other features, aspects and elements of the various example embodiments will be readily apparent to a person skilled in the art in view of the subject disclosure.

According to a first aspect, there is provided a radio access network node comprising means for: receiving one or more control plane messages indicating a plurality of quality-of-service profiles for a quality-of-service flow for a logical connection between a user equipment and a data network via the radio access network; receiving user plane messages for the quality-of-service flow at the radio access network node, wherein an individual user plane message comprises a header comprising at least a first field; determining one of the plurality of quality-of-service profiles to adopt for the quality-of-service flow based at least partly on the first field and an indication in the one or more control plane messages of a mapping of the plurality of quality-of service profiles to a plurality of values for the first field.

The determining may comprise determining one of the plurality of quality-of-service profiles to adopt for handling content of an individual user plane message for the quality-of-service flow based at least partly on the first field of the individual user plane message.

The determining may comprise determining one of the plurality of quality-of-service profiles to use for the quality-of-service flow based at least partly on an average value of the first field over a plurality of the user plane messages.

The header of the user plane messages may indicate that a carried protocol data unit is part of a set of protocol data units carrying a unit of information at the application-level.

The first field may be part of information about the set of protocol data units.

According to a second aspect, there is provided a radio access network node, comprising means for: receiving one or more control plane messages indicating a plurality of quality-of-service profiles for a quality-of-service flow for a logical connection between a user equipment and a data network via the radio access network; receiving from the user equipment an indication of an application-level attribute of one or more units of information at the application level for transmission from the user equipment; and determining one of the plurality of quality-of-service profiles to adopt for the quality-of-service flow based at least partly on the indication from the user equipment.

According to a third aspect, there is provided an apparatus, comprising means for: receiving by a user plane function of a mobile communication system from a data network at least one application-level packet for a user equipment; generating by the user plane function a user plane message to carry the application-level packet to a radio access network node serving the user equipment;
wherein the generating comprises determining a value for a first field of a header of the user plane message based at least in part on information from the application-level packet, and a control plane mapping between the information from the application-level packet and the value for the first field; and sending the user plane message to the radio access network node.

The information from the application-level packet may comprise an indication of the application-level attribute of a payload of the application-level packet, and the apparatus may comprise means for receiving by the user plane function one or more control plane messages indicating a mapping of a plurality of application-level attributes to a plurality of values of the first field.

The application-level packet may include an indication that the application-level packet comprises part of an application-level unit of information, and the header of the user plane message may indicate that a carried protocol data unit is part of a set of protocol data units carrying an individual application-level unit of information.

The first field may be part of header information about the set of protocol data units.

According to a fourth aspect, there is provided a user equipment, comprising means for: receiving one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determining one of the plurality of quality-of-service profiles to adopt for the uplink quality-of-service flow, based on one or more application-level attributes of one or more individual application-level units of information for sending to the data network via the radio access network, and the mapping; and sending an indication of the determined quality-of-service profile for the uplink quality-of-service flow to the radio access network.

According to a fifth aspect, there is provided an apparatus comprising means for: sending, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

The one or more messages for the control plane function may indicate a mapping of a plurality of application-level attributes to the plurality of quality-of-service requirement options.

According to a sixth aspect, there is provided an apparatus comprising means for: receiving, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determining a plurality of quality-of-service parameter sets for a quality-of-service flow for a logical connection between a user equipment and a data network via a radio access network, based on the plurality of quality-of-service requirement options; and sending one or more messages for another control plane function of the mobile communication system indicating the plurality of quality-of-service parameter sets for the quality of service flow, and a mapping of the plurality of header field values to the plurality of quality-of-service parameter sets.

The one or more messages received by the control plane function may indicate a mapping of a plurality of application-level attributes to the plurality of quality-of-service requirement options for the application; and the one or more messages for the another control plane function may include a mapping of a plurality of application-level attributes to the plurality of quality-of-service parameter sets.

According to a seventh aspect, there is provided an apparatus comprising means for: sending by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

The apparatus may comprise means for sending by the control plane function one or more messages for a user plane function of the mobile communication system, wherein the one or more messages indicate a mapping of a plurality of application-level attributes to the plurality of user plane message header field values.

The user plane message header field may be part of information about a set of protocol data units including a protocol data unit carried by the user plane message.

The apparatus may comprise means for sending by the control plane function to a user equipment one or more control plane messages indicating a mapping of a plurality of application-level attributes to a plurality of quality-of-service profiles for an uplink quality of service flow.

According to an eighth aspect, there is provided a method, comprising: receiving at a node of a radio access network of a mobile communication system one or more control plane messages indicating a plurality of quality-of-service profiles for a quality-of-service flow for a logical connection between a user equipment and a data network via the radio access network; receiving user plane messages for the quality-of-service flow at the radio access network node, wherein an individual user plane message comprises a header comprising at least a first field; determining at the radio access network node one of the plurality of quality-of-service profiles to adopt for the quality-of-service flow based at least partly on the first field and an indication in the one or more control plane messages of a mapping of the plurality of quality-of service profiles to a plurality of values for the first field.

The determining may comprise determining one of the plurality of quality-of-service profiles to adopt for handling content of an individual user plane message for the quality-of-service flow based at least partly on the first field of the individual user plane message.

The determining may comprise determining one of the plurality of quality-of-service profiles to use for the quality-of-service flow based at least partly on an average value of the first field over a plurality of the user plane messages.

The header of the user plane messages may indicate that a carried protocol data unit is part of a set of protocol data units carrying a unit of information at the application-level.

The first field may be part of information about the set of protocol data units.

According to a ninth aspect, there is provided a method, comprising: receiving at a node of a radio access network of a mobile communication system one or more control plane messages indicating a plurality of quality-of-service profiles for a quality-of-service flow for a logical connection between a user equipment and a data network via the radio access network; receiving from the user equipment an indication of an application-level attribute of one or more units of information at the application level for transmission from the user equipment to the node of the radio access network; and determining at the radio access network node one of the plurality of quality-of-service profiles to adopt for the quality-of-service flow based at least partly on the indication from the user equipment.

According to a tenth aspect, there is provided a method comprising: receiving by a user plane function of a mobile communication system from a data network at least one application-level packet for a user equipment;
generating by the user plane function a user plane message to carry the application-level packet to a radio access network node serving the user equipment; wherein the generating comprises determining a value for a first field of a header of the user plane message based at least in part on information from the application-level packet, and a control plane mapping between the information from the application-level packet and the value for the first field; and sending the user plane message to the radio access network node.

The information from the application-level packet may comprise an indication of the application-level attribute of a payload of the application-level packet, and the method may comprise: receiving by the user plane function one or more control plane messages indicating a mapping of a plurality of application-level attributes to a plurality of values of the first field.

The application-level packet may include an indication that the application-level packet comprises part of an application-level unit of information, and the header of the user plane message may indicate that a carried protocol data unit is part of a set of protocol data units carrying an individual application-level unit of information.

The first field may be part of header information about the set of protocol data units.

According to an eleventh aspect, there is provided a method, comprising: receiving at a user equipment one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determining at the user equipment one of the plurality of quality-of-service profiles to adopt for the uplink quality-of-service flow, based on one or more application-level attributes of one or more individual application-level units of information for sending to the data network via the radio access network, and the mapping; and sending an indication of the determined quality-of-service profile for the uplink quality-of-service flow to the radio access network.

According to a twelfth aspect, there is provided a method comprising: sending, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

The one or more messages for the control plane function may indicate a mapping of a plurality of application-level attributes to the plurality of quality-of-service requirement options.

According to a thirteenth aspect, there is provided a method comprising: receiving, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determining a plurality of quality-of-service parameter sets for a quality-of-service flow for a logical connection between a user equipment and a data network via a radio access network, based on the plurality of quality-of-service requirement options; and sending one or more messages for another control plane function of the mobile communication system indicating the plurality of quality-of-service parameter sets for the quality of service flow, and a mapping of the plurality of header field values to the plurality of quality-of-service parameter sets.

The one or more messages received by the control plane function may indicate a mapping of a plurality of application-level attributes to the plurality of quality-of-service requirement options for the application; and the one or more messages for the another control plane function may include a mapping of a plurality of application-level attributes to the plurality of quality-of-service parameter sets.

According to a fourteenth aspect, there is provided a method comprising: sending by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

The method may further comprise sending by the control plane function one or more messages for a user plane function of the mobile communication system, and the one or more messages may indicate a mapping of a plurality of application-level attributes to the plurality of user plane message header field values.

The user plane message header field may be part of information about a set of protocol data units including a protocol data unit carried by the user plane message.

The method may further comprise: sending by the control plane function to a user equipment one or more control plane messages indicating a mapping of a plurality of application-level attributes to a plurality of quality-of-service profiles for an uplink quality of service flow.

According to a fifteenth aspect, there is provided a radio access network node comprising: at least one processor; and at least one memory including computer program code, the at least one memory and computer program code configured to, with the at least one processor, cause the node to perform: receiving one or more control plane messages indicating a plurality of quality-of-service profiles for a quality-of-service flow for a logical connection between a user equipment and a data network via the radio access network; receiving user plane messages for the quality-of-service flow at the radio access network node, wherein an individual user plane message comprises a header comprising at least a first field; determining one of the plurality of quality-of-service profiles to adopt for the quality-of-service flow based at least partly on the first field and an indication in the one or more control plane messages of a mapping of the plurality of quality-of service profiles to a plurality of values for the first field.

The determining may comprise determining one of the plurality of quality-of-service profiles to adopt for handling content of an individual user plane message for the quality-of-service flow based at least partly on the first field of the individual user plane message.

The determining may comprise determining one of the plurality of quality-of-service profiles to use for the quality-of-service flow based at least partly on an average value of the first field over a plurality of the user plane messages.

The header of the user plane messages may indicate that a carried protocol data unit is part of a set of protocol data units carrying a unit of information at the application-level.

The first field may be part of information about the set of protocol data units.

According to a sixteenth aspect, there is provided a radio access network node, comprising: at least one processor; and at least one memory including computer program code, the at least one memory and computer program code configured to, with the at least one processor, cause the node to perform: receiving one or more control plane messages indicating a plurality of quality-of-service profiles for a quality-of-service flow for a logical connection between a user equipment and a data network via the radio access network; receiving from the user equipment an indication of an application-level attribute of one or more units of information at the application level for transmission from the user equipment; and determining one of the plurality of quality-of-service profiles to adopt for the quality-of-service flow based at least partly on the indication from the user equipment.

According to a seventeenth aspect, there is provided an apparatus, comprising: at least one processor; and at least one memory including computer program code, the at least one memory and computer program code configured to, with the at least one processor, cause the apparatus to perform: receiving by a user plane function of a mobile communication system from a data network at least one application-level packet for a user equipment; generating by the user plane function a user plane message to carry the application-level packet to a radio access network node serving the user equipment; wherein the generating comprises determining a value for a first field of a header of the user plane message based at least in part on information from the application-level packet, and a control plane mapping between the information from the application-level packet and the value for the first field; and sending the user plane message to the radio access network node.

The information from the application-level packet may comprise an indication of the application-level attribute of a payload of the application-level packet, and the at least one memory and computer program code may be configured to, with the at least one processor, cause the apparatus to receive by the user plane function one or more control plane messages indicating a mapping of a plurality of application-level attributes to a plurality of values of the first field.

The application-level packet may include an indication that the application-level packet comprises part of an application-level unit of information, and the header of the user plane message may indicate that a carried protocol data unit is part of a set of protocol data units carrying an individual application-level unit of information.

The first field may be part of header information about the set of protocol data units.

According to an eighteenth aspect, there is provided a user equipment, comprising: at least one processor; and at least one memory including computer program code, the at least one memory and computer program code configured to, with the at least one processor, cause the user equipment to perform: receiving one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determining one of the plurality of quality-of-service profiles to adopt for the uplink quality-of-service flow, based on one or more application-level attributes of one or more individual application-level units of information for sending to the data network via the radio access network, and the mapping; and sending an indication of the determined quality-of-service profile for the uplink quality-of-service flow to the radio access network.

According to a nineteenth aspect, there is provided an apparatus comprising: at least one processor; and at least one memory including computer program code, the at least one memory and computer program code configured to, with the at least one processor, cause the apparatus to perform: sending, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

The one or more messages for the control plane function may indicate a mapping of a plurality of application-level attributes to the plurality of quality-of-service requirement options.

According to a twentieth aspect, there is provided an apparatus comprising: at least one processor; and at least one memory including computer program code, the at least one memory and computer program code configured to, with the at least one processor, cause the apparatus to perform: receiving, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determining a plurality of quality-of-service parameter sets for a quality-of-service flow for a logical connection between a user equipment and a data network via a radio access network, based on the plurality of quality-of-service requirement options; and sending one or more messages for another control plane function of the mobile communication system indicating the plurality of quality-of-service parameter sets for the quality of service flow, and a mapping of the plurality of header field values to the plurality of quality-of-service parameter sets.

The one or more messages received by the control plane function may indicate a mapping of a plurality of application-level attributes to the plurality of quality-of-service requirement options for the application; and the one or more messages for the another control plane function may include a mapping of a plurality of application-level attributes to the plurality of quality-of-service parameter sets.

According to a twenty-first aspect, there is provided an apparatus comprising: at least one processor; and at least one memory including computer program code, the at least one memory and computer program code configured to, with the at least one processor, cause the apparatus to perform: sending by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

The at least one memory and computer program code may be configured to, with the at least one processor, cause the apparatus to send by the control plane function one or more messages for a user plane function of the mobile communication system, and the one or more messages may indicate a mapping of a plurality of application-level attributes to the plurality of user plane message header field values.

The user plane message header field may be part of information about a set of protocol data units including a protocol data unit carried by the user plane message.

The at least one memory and computer program code may be configured to, with the at least one processor, cause the apparatus to send by the control plane function to a user equipment one or more control plane messages indicating a mapping of a plurality of application-level attributes to a plurality of quality-of-service profiles for an uplink quality of service flow.

According to a twenty-second aspect, there is provided a radio access network node, comprising: receiving circuitry for receiving one or more control plane messages indicating a plurality of quality-of-service profiles for a quality-of-service flow for a logical connection between a user equipment and a data network via the radio access network; receiving circuitry for receiving user plane messages for the quality-of-service flow, wherein an individual user plane message comprises a header comprising at least a first field; and determining circuitry for determining one of the plurality of quality-of-service profiles to adopt for the quality-of-service flow based at least partly on the first field and an indication in the one or more control plane messages of a mapping of the plurality of quality-of service profiles to a plurality of values for the first field.

According to a twenty-third aspect, there is provided a radio access network node, comprising: receiving circuitry for receiving one or more control plane messages indicating a plurality of quality-of-service profiles for a quality-of-service flow for a logical connection between a user equipment and a data network via the radio access network; receiving circuitry for receiving from the user equipment an indication of an application-level attribute of one or more units of information at the application level for transmission from the user equipment to the node of the radio access network; and determining circuitry for determining one of the plurality of quality-of-service profiles to adopt for the quality-of-service flow based at least partly on the indication from the user equipment.

According to a twenty-fourth aspect, there is provided an apparatus, comprising: receiving circuitry for receiving by a user plane function of a mobile communication system from a data network at least one application-level packet for a user equipment; generating circuitry for generating by the user plane function a user plane message to carry the application-level packet to a radio access network node serving the user equipment; wherein the generating comprises determining a value for a first field of a header of the user plane message based at least in part on information from the application-level packet, and a control plane mapping between the information from the application-level packet and the value for the first field; and sending circuitry for sending the user plane message to the radio access network node.

According to a twenty-fifth aspect, there is provided a user equipment, comprising: receiving circuitry for receiving one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determining circuitry for determining one of the plurality of quality-of-service profiles to adopt for the uplink quality-of-service flow, based on one or more application-level attributes of one or more individual application-level units of information for sending to the data network via the radio access network, and the mapping; and sending circuitry for sending an indication of the determined quality-of-service profile for the uplink quality-of-service flow to the radio access network.

According to a twenty-sixth aspect, there is provided an apparatus comprising: sending circuitry for sending, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

According to a twenty-seventh aspect, there is provided an apparatus comprising: receiving circuitry for receiving, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determining circuitry for determining a plurality of quality-of-service parameter sets for a quality-of-service flow for a logical connection between a user equipment and a data network via a radio access network, based on the plurality of quality-of-service requirement options; and sending circuitry for sending one or more messages for another control plane function of the mobile communication system indicating the plurality of quality-of-service parameter sets for the quality of service flow, and a mapping of the plurality of header field values to the plurality of quality-of-service parameter sets.

According to a twenty-eighth aspect, there is provided an apparatus comprising: sending circuitry for sending by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

According to a twenty-ninth aspect, there is provided a computer readable medium comprising program instructions stored thereon for performing: receiving at a node of a radio access network of a mobile communication system one or more control plane messages indicating a plurality of quality-of-service profiles for a quality-of-service flow for a logical connection between a user equipment and a data network via the radio access network; receiving user plane messages for the quality-of-service flow at the radio access network node, wherein an individual user plane message comprises a header comprising at least a first field; determining at the radio access network node one of the plurality of quality-of-service profiles to adopt for the quality-of-service flow based at least partly on the first field and an indication in the one or more control plane messages of a mapping of the plurality of quality-of service profiles to a plurality of values for the first field.

According to a thirtieth aspect, there is provided a computer readable medium comprising program instructions stored thereon for performing: receiving at a node of a radio access network of a mobile communication system one or more control plane messages indicating a plurality of quality-of-service profiles for a quality-of-service flow for a logical connection between a user equipment and a data network via the radio access network; receiving from the user equipment an indication of an application-level attribute of one or more units of information at the application level for transmission from the user equipment to the node of the radio access network; and determining at the radio access network node one of the plurality of quality-of-service profiles to adopt for the quality-of-service flow based at least partly on the indication from the user equipment.

According to a thirty-first aspect, there is provided a computer readable medium comprising program instructions stored thereon for performing: receiving by a user plane function of a mobile communication system from a data network at least one application-level packet for a user equipment; generating by the user plane function a user plane message to carry the application-level packet to a radio access network node serving the user equipment; wherein the generating comprises determining a value for a first field of a header of the user plane message based at least in part on information from the application-level packet, and a control plane mapping between the information from the application-level packet and the value for the first field; and sending the user plane message to the radio access network node.

According to a thirty-second aspect, there is provided a computer readable medium comprising program instructions stored thereon for performing: receiving at a user equipment one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determining at the user equipment one of the plurality of quality-of-service profiles to adopt for the uplink quality-of-service flow, based on one or more application-level attributes of one or more individual application-level units of information for sending to the data network via the radio access network, and the mapping; and sending an indication of the determined quality-of-service profile for the uplink quality-of-service flow to the radio access network.

According to a thirty-third aspect, there is provided a computer readable medium comprising program instructions stored thereon for performing: sending, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

According to a thirty-fourth aspect, there is provided a computer readable medium comprising program instructions stored thereon for performing: receiving, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determining a plurality of quality-of-service parameter sets for a quality-of-service flow for a logical connection between a user equipment and a data network via a radio access network, based on the plurality of quality-of-service requirement options; and sending one or more messages for another control plane function of the mobile communication system indicating the plurality of quality-of-service parameter sets for the quality of service flow, and a mapping of the plurality of header field values to the plurality of quality-of-service parameter sets.

According to a thirty-fifth aspect, there is provided a computer readable medium comprising program instructions stored thereon for performing: sending by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

According to a thirty-sixth aspect, there is provided a non-transitory computer readable medium comprising program instructions stored thereon for performing: receiving at a node of a radio access network of a mobile communication system one or more control plane messages indicating a plurality of quality-of-service profiles for a quality-of-service flow for a logical connection between a user equipment and a data network via the radio access network; receiving user plane messages for the quality-of-service flow at the radio access network node, wherein an individual user plane message comprises a header comprising at least a first field; determining at the radio access network node one of the plurality of quality-of-service profiles to adopt for the quality-of-service flow based at least partly on the first field and an indication in the one or more control plane messages of a mapping of the plurality of quality-of service profiles to a plurality of values for the first field.

According to a thirty-seventh aspect, there is provided a non-transitory computer readable medium comprising program instructions stored thereon for performing: receiving at a node of a radio access network of a mobile communication system one or more control plane messages indicating a plurality of quality-of-service profiles for a quality-of-service flow for a logical connection between a user equipment and a data network via the radio access network; receiving from the user equipment an indication of an application-level attribute of one or more units of information at the application level for transmission from the user equipment to the node of the radio access network; and determining at the radio access network node one of the plurality of quality-of-service profiles to adopt for the quality-of-service flow based at least partly on the indication from the user equipment.

According to a thirty-eighth aspect, there is provided a non-transitory computer readable medium comprising program instructions stored thereon for performing: receiving by a user plane function of a mobile communication system from a data network at least one application-level packet for a user equipment; generating by the user plane function a user plane message to carry the application-level packet to a radio access network node serving the user equipment; wherein the generating comprises determining a value for a first field of a header of the user plane message based at least in part on information from the application-level packet, and a control plane mapping between the information from the application-level packet and the value for the first field; and sending the user plane message to the radio access network node.

According to a thirty-ninth aspect, there is provided a non-transitory computer readable medium comprising program instructions stored thereon for performing: receiving at a user equipment one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determining at the user equipment one of the plurality of quality-of-service profiles to adopt for the uplink quality-of-service flow, based on one or more application-level attributes of one or more individual application-level units of information for sending to the data network via the radio access network, and the mapping; and sending an indication of the determined quality-of-service profile for the uplink quality-of-service flow to the radio access network.

According to a fortieth aspect, there is provided a non-transitory computer readable medium comprising program instructions stored thereon for performing: sending, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

According to a forty-first aspect, there is provided a non-transitory computer readable medium comprising program instructions stored thereon for performing: receiving, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determining a plurality of quality-of-service parameter sets for a quality-of-service flow for a logical connection between a user equipment and a data network via a radio access network, based on the plurality of quality-of-service requirement options; and sending one or more messages for another control plane function of the mobile communication system indicating the plurality of quality-of-service parameter sets for the quality of service flow, and a mapping of the plurality of header field values to the plurality of quality-of-service parameter sets.

According to a forty-second aspect, there is provided a non-transitory computer readable medium comprising program instructions stored thereon for performing: sending by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

According to a forty-third aspect, there is provided a computer program comprising computer executable code which when run on at least one processor is configured to cause a radio access network node at least to: receive one or more control plane messages indicating a plurality of quality-of-service profiles for a quality-of-service flow for a logical connection between a user equipment and a data network via the radio access network; receive user plane messages for the quality-of-service flow, wherein an individual user plane message comprises a header comprising at least a first field; determine node one of the plurality of quality-of-service profiles to adopt for the quality-of-service flow based at least partly on the first field and an indication in the one or more control plane messages of a mapping of the plurality of quality-of service profiles to a plurality of values for the first field.

According to a forty-fourth aspect, there is provided a computer program comprising computer executable code which when run on at least one processor is configured to cause a radio access network node at least to: receive one or more control plane messages indicating a plurality of quality-of-service profiles for a quality-of-service flow for a logical connection between a user equipment and a data network via the radio access network; receive from the user equipment an indication of an application-level attribute of one or more units of information at the application level for transmission from the user equipment to the node; and determine one of the plurality of quality-of-service profiles to adopt for the quality-of-service flow based at least partly on the indication from the user equipment.

According to a forty-fifth aspect, there is provided a computer program comprising computer executable code which when run on at least one processor is configured to cause an apparatus at least to: receive by a user plane function of a mobile communication system from a data network at least one application-level packet for a user equipment; generate by the user plane function a user plane message to carry the application-level packet to a radio access network node serving the user equipment; wherein the generating comprises determining a value for a first field of a header of the user plane message based at least in part on information from the application-level packet, and a control plane mapping between the information from the application-level packet and the value for the first field; and send the user plane message to the radio access network node.

According to a forty-sixth aspect, there is provided a computer program comprising computer executable code which when run on at least one processor is configured to cause a user equipment at least to: receive one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles; determine one of the plurality of quality-of-service profiles to adopt for the uplink quality-of-service flow, based on one or more application-level attributes of one or more individual application-level units of information for sending to the data network via the radio access network, and the mapping; and send an indication of the determined quality-of-service profile for the uplink quality-of-service flow to the radio access network.

According to a forty-seventh aspect, there is provided a computer program comprising computer executable code which when run on at least one processor is configured to cause an apparatus at least to: send, by an application function, one or more messages for a control plane function of a mobile communication system, wherein the one or more messages indicate: a plurality of quality-of-service requirement options for an application; and a mapping between the plurality of quality-of-service requirement options for the application and a plurality of header field values for user plane messages for carrying data for the application in the mobile communication system.

According to a forty-eighth aspect, there is provided a computer program comprising computer executable code which when run on at least one processor is configured to cause an apparatus at least to: receive, by a control plane function of a mobile communication system from an application function for an application, one or more messages indicating a plurality of quality-of-service requirement options for the application, and a mapping between the plurality of quality-of-service requirement options for the application and a plurality of header field values for user plane messages for carrying data for the application in the mobile communication system; determine a plurality of quality-of-service parameter sets for a quality-of-service flow for a logical connection between a user equipment and a data network via a radio access network, based on the plurality of quality-of-service requirement options; and send one or more messages for another control plane function of the mobile communication system indicating the plurality of quality-of-service parameter sets for the quality of service flow, and a mapping of the plurality of header field values to the plurality of quality-of-service parameter sets.

According to a forty-ninth aspect, there is provided a computer program comprising computer executable code which when run on at least one processor is configured to cause an apparatus at least to: send by a control plane function to a node of a radio access network of a mobile communication system one or more messages indicating a plurality of quality-of-service profiles for a downlink quality-of-service flow for a logical connection between a user equipment and a data network via the radio access network, and a mapping of a plurality of user plane message header field values to the plurality of quality-of-service profiles for the downlink quality-of-service flow.

In the above and elsewhere described herein, various example embodiments of the subject disclosure are described. It should be appreciated that further example embodiments may be provided by the combination of any two or more of the aspects described above or otherwise described herein.

### BRIEF DESCRIPTION OF DRAWINGS

In the following, some example embodiments will now be described, by way of non-limiting and illustrative example only, with reference to the accompanying drawings in which:

FIG. 1 shows a representation of a mobile communication system according to some example embodiments;

FIG. 2 shows a representation of a control apparatus according to some example embodiments;

FIG. 3 shows a representation of an apparatus according to some example embodiments;

FIG. 4 shows a representation of a group of GTP-U messages carrying an application-level unit of information;

FIG. 5 shows a representation of operations by an instance of an application function according to some example embodiments;

FIG. 6 shows a representation of operations by an instance of a control plane function of a core network of a mobile communication system according to some example embodiments;

FIG. 7 shows a representation of operations by an instance of another control plane function of a core network of a mobile communication system according to some example embodiments;

FIG. 8 shows a representation of operations by a user plane function of a core network of a mobile communication system according to some example embodiments;

FIG. 9 shows a representation of operations by a radio access network node of a mobile communication system according to some example embodiments;

FIG. 10 shows a representation of operations by a user equipment according to some example embodiments;

FIG. 11 shows a representation of messaging according to some example embodiments; and

FIG. 12 shows a representation of further messaging according to some example embodiments.

### DETAILED DESCRIPTION

In the following, certain example embodiments are explained with reference to mobile communication devices capable of communication via a wireless cellular system and mobile communication systems serving such mobile communication devices. However, it is to be expressly understood that the description of any example embodiments is provided by way of non-limiting and illustrative example only, and that it is by no way intended to be understood as limiting.

The terminology used herein is generally provided for the purpose of describing certain example embodiments only and is not intended to be limiting. In the following, all technical and scientific terms used herein may have the same meaning as commonly understood by one of ordinary skill in the art to which this subject disclosure pertains, unless otherwise defined.

References in the subject disclosure to “an example embodiment,” “some example embodiments,” “certain example embodiments,” “various example embodiments,” and the like indicate that the referenced embodiment(s) described may include particular feature(s), structure(s), or characteristic(s), but it is not necessary that every example embodiment described herein includes the particular feature(s), structure(s), or characteristic(s). Moreover, such phrases are not necessarily referring to the same example embodiment. Further, when particular feature(s), structure(s), or characteristic(s) are described in connection with an example embodiment, it is submitted that it is within the knowledge of one skilled in the art to combine such feature(s), structure(s), or characteristic(s) in connection with any other example embodiments described herein, whether or not such combination is explicitly described.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, unless stated explicitly, performing a step “based on A” does not indicate that the step is performed solely based on “A”, and the step may be based on “A” in addition to one or more other features, elements, components (e.g., “B”, “C”, “D” and so forth) and/or combinations thereof. Analogous considerations apply to performing a step “in response to A”.

As used herein, unless stated explicitly, performing a step “in response to A” does not indicate that the step is performed immediately after “A”, and one or more intervening steps may be included between “A” and the step.

As used herein, the expressions “first X” and “second X” include the options that “first X” is the same as “second X” and that “first X” is different from “second X”, unless otherwise specified. Thus, it shall be understood that although the terms “first,” “second,” and the like may be used herein to describe various elements, these elements should not be limited by these terms. These terms are only used to distinguish one element from another. For example, a “first element” could be termed a “second element”, and similarly, a “second element” could be termed a “first element” without departing from the scope of the subject disclosure.

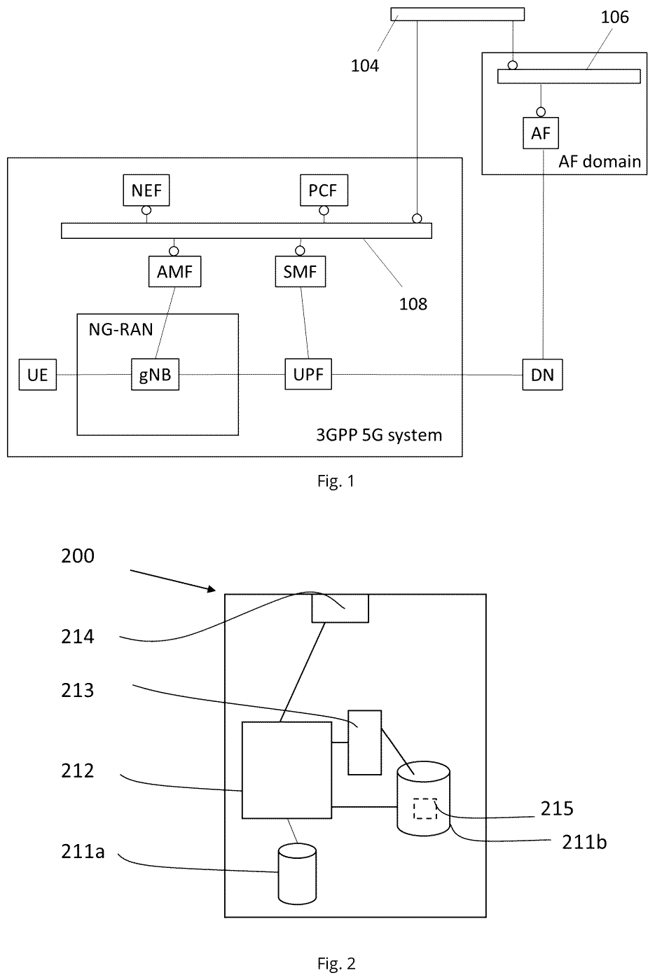

Before explaining in detail the various example embodiments, certain facets of a wireless communication system are briefly explained with reference to FIG. 1 to assist in understanding the technology underlying the described example embodiments.

FIG. 1 shows a schematic representation of some elements of a 3GPP 5G mobile communication system (5GS). The 5GS comprises a 5G radio access network (5GRAN) or next generation radio access network (NG-RAN) for achieving radio access between a terminal or user equipment (UE) and a 5G core network (5GC) of the 5GS. The 5GC adopts an open and modular service platform: the Service-Based Architecture (SBA). SBA provides a cloud-native service framework in which mobile core network functionalities (e.g., authentication, mobility management, etc.) are supported by instances of network functions (NFs), self-contained software applications that can be run on hardware hosted by cloud infrastructure. Services exposed by one NF instance (service producer) to another NF instance (service consumer) are described using application programming interface (API) specifications that identify the set of accessible service data and indicate the authorized operations on these service data. The NF instances of the core domain are interconnected on a logically shared infrastructure comprising a CN domain message bus 108. NF instances offer, via the CN domain message bus 108, services accessible to any other authorized NF instances through APIs (Application Programming Interfaces) referred to as service-based interfaces (SBI).

The services exposed by the network functions of the core domain may also be made open to application functions (AF) of an AF domain via a network exposure function (NEF) of the core domain, through the CN domain message bus 108, an inter-domain message bus 104 and an AF domain message bus 106. The NEF exposes secured APIs to AFs.

The core domain of the 5GS comprises one or more instances of other control plane functions not shown in FIG. 1, e.g., a Network Slice Selection Function (NSSF); a Network Repository Function (NRF); Unified Data Management (UDM); and Authentication Server Function (AUSF), in addition to one or more instances of the control plane functions illustrated in FIG. 1 including one or more instances of control plane functions referred to as Policy Control Function (PCF), Access and Mobility Management Function (AMF) and Session Management Function (SMF).

The 5G-RAN may comprise one or more gNodeB (NB) or one or more gNodeB (gNB) distributed unit functions connected to one or more gNodeB (gNB) centralized unit functions. The gNB is part of the user plane providing access between UE and one or more data networks (DN) via one or more user plane function (UPF) instances.

FIG. 2 illustrates an example of a control apparatus 200 for running one or more functions illustrated in FIG. 1. The functions illustrated in FIG. 1 may be run on respective control apparatus, or may share a control apparatus with one or more other functions. The control apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may, for example, allow to perform one or more of the various example embodiments of the subject disclosure. The software code 215 may be stored in the ROM 211b.

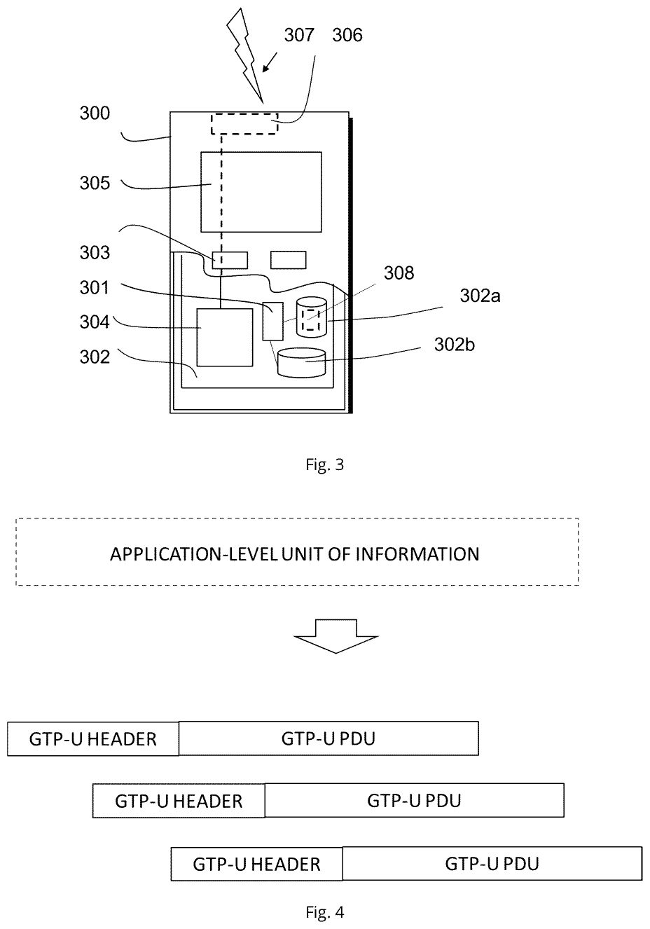

FIG. 3 illustrates an example of a user equipment 300, such as the user equipment illustrated in FIG. 1. The terminal 300 may be provided by any device capable of sending and receiving radio signals. Non-limiting and illustrative examples comprise a mobile station (MS) or mobile device (such as, a mobile phone or what is known as a ‘smart phone’), a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The user equipment 300 may provide, for example, communication of data for carrying communications. The communications may be one or more of voice, electronic mail (email), text message, multimedia, data, machine data and so on.

The user equipment 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the mobile device.

The user equipment 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may, for example, allow to perform one or more of the various example embodiments of the subject disclosure. The software code 308 may be stored in the ROM 302a.

The processor, storage and other relevant control apparatus can be provided on an appropriate circuit board and/or in chipsets. This feature is denoted by reference 304. The device may optionally have a user interface, such as keypad 305, touch sensitive screen or pad, combinations thereof or the like. Optionally one or more of a display, a speaker and a microphone may be provided depending on the type of the device.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

The operation of a node of a radio access network for a logical connection between a user equipment and a data network via the radio access network may involve the radio access network node switching between quality-of-service profiles for a quality-of-service flow based on congestion in the radio access network.

A mobile communication system may be used to carry application-level units of information for a media application between a data network (DN) and one or more user equipments. In some example embodiments described below, the example of individual application-level units of information (e.g., video frames) are carried between the data network and UE by respective sets of protocol data units (PDUs), referred to as PDU sets. The GPRS Tunnelling Protocol (GTP) user plane messages carrying a PDU set include a header field indicating that the carried PDU is part of a PDU set. The RAN node serving the UE handles the GTP user plane messages according to a quality-of-service (QOS) profile for a QoS flow for the logical connection between the data network and the UE for the media application. This logical connection between the data network and the UE may be referred to as a PDU session.

In some example embodiments described below, the example of application-level packets based on the Real-time Transport Protocol (RTP) carry application-level units of information (e.g., I-frame, P-frame, video slice, etc.) for a media application. An application-level unit of information may be carried by one or more RTP packets. RTP is a network protocol for delivering audio and video over IP networks. A RTP packet comprises a RTP header and a RTP payload. An I-frame (Intra-coded frame) is a complete image, such as a JPG or BMP image file. A P-frame (Predicted frame) holds only the changes in the image from the previous frame. Examples of alternatives to RTP are Dynamic Adaptive Streaming over HTTP (DASH) and the protocol known as QUIC.

FIG. 4 shows a representation of a set of GTP-U messages for carrying an application-level unit of information. Each GTP-U message includes a GTP-U header and a GTP-U payload (protocol data unit (PDU)). The GTP-U header includes fields indicating that the carried PDU is part of a PDU set representing application-level information and information about the PDU Set. For example, the GTP-U header may be the GTPv1-U header defined in 3GPP TS29.281, and may include GTP-U extension headers.

The GTP-U header may carry the following PDU set information: an indication of the sequence number of the PDU Set including the carried PDU; an indication of the end PDU of the PDU set; an indication of the sequence number of the carried PDU within the PDU set; an indication of the size of the PDU set in bytes; and an indication of the relative importance of the PDU set compared to other PDU sets. The PDU set information may be as described in TS23.501 V18.2.2 clause 5.37.5.2.

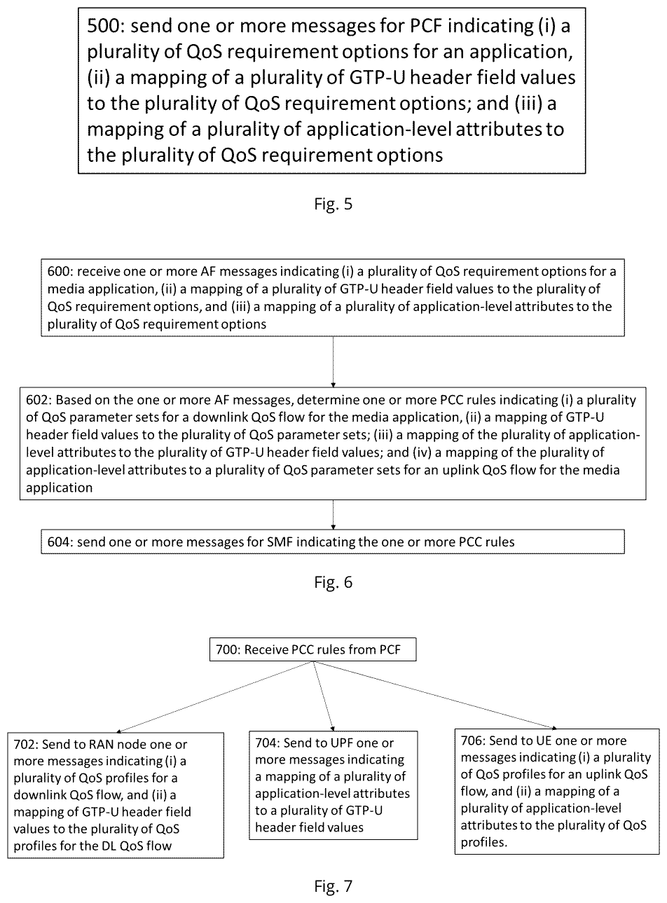

FIG. 5 shows a representation of operations by an AF instance according to some example embodiments. The AF instance provides a PCF instance, via a NEF instance, with one or more messages indicating a plurality of QoS requirement options for an application, a mapping of a plurality of GTP-U header field values to the plurality of QoS requirement options, and a mapping of a plurality of application-level attributes (e.g., media types, video frame types) to the plurality of QoS requirement options (OPERATION 400).

Table 1 below shows an example of information sent by the AF to the PCF.

TABLE 1

| | | QoS & Alt-QoS | PDU Set Info./ |
|---|---|---|---|
| | Application-level | Requirements | Meta-Data |
| | Attribute | (to be applied in the | (for GTP-U |
| | (media type) | RAN) | header) |
| 1 | I-Frame (video) | QoS Req, Alt-QoS | PDU Set |
| | | Req-1, Alt-QoS | Importance = 2 |
| | | Req-2 | |
| 2 | P-Frame (video) | QoS Req, Alt-QoS | PDU Set |
| | | Req-1, Alt-QoS | Importance = 3 |
| | | Req-2 | |
| 3 | Avatar | Alt-QoS Req-3 | PDU Set |
| | | | Importance = 1 |

As shown in Table 1, more than one QoS requirement option may be mapped to a single application-level attribute and to a single GTP-U header field value. This allows for some adaptation of QoS for a specific application-level attribute according to RAN conditions such as congestion in the RAN.

FIG. 6 shows a representation of operations by the PCF instance according to some example embodiments. The PCF instance receives the one or more AF messages indicating a plurality of QoS requirement options for the multi-media application, and a mapping of a plurality of application-level attributes to the plurality of QoS requirement options and GTP-U header field values (OPERATION 600). The PCF determines one or more policy and charging control (PCC) rules based on the one or more AF messages (OPERATION 602), and sends the one or more PCC rules to the SMF instance associated with the UPF instance for the PDU session for the application (OPERATION 604). The one or more PCC rules indicate (i) a plurality of QoS parameter sets (QOS Parameter Set and one or more Alternative QoS Parameter Sets) for a downlink (DL) QOS flow for the media application, (ii) a mapping of GTP-U header field values to the plurality of QoS parameter sets for the DL QoS flow; (iii) a mapping of a plurality of application-level attributes to the plurality of GTP-U header field values. The one or more PCC rules may also indicate a plurality of QoS parameter sets for an uplink (UL) QOS flow for the media application; and (v) a mapping of a plurality of application-level attributes to the plurality of QoS parameter sets for the UL QoS flow.

According to one example embodiment, the GTP-U header field values that are mapped to the plurality of QoS parameter sets (QOS Parameter Set and one or more Alternative QoS Parameter Sets) are values of the PDU Importance Set field of the PDU set information mentioned above. Alternatively, the PDU set information may be expanded to include an extra GTP-U header field (which may, for example, be referred to as a “Media Type” field), and a plurality of values for this extra header field may be mapped to the plurality of QoS parameter sets.

Each QoS parameter set of the plurality of QoS parameter sets (QoS Parameter Set and one or more Alternative QoS Parameter Sets) may comprise one or more QoS parameters.

FIG. 7 shows a representation of operations by the SMF instance associated with the RAN node serving the UE of the PDU session for the application, according to some example embodiments. The SMF instance receives the one or more PCC rules mentioned above from the PCF (OPERATION 700). Based on these one or more PCC rules, the SMF instance sends one or more control plane messages for the RAN node serving the UE (OPERATION 702). The one or more messages indicate (i) a plurality of QoS profiles (QOS Profile and one or more Alternative QoS Profiles) for the downlink QoS flow for the media application, and (ii) a mapping of GTP-U header field values to the plurality of QoS profiles (QOS Profile and one or more Alternative QoS Profiles).

Table 2 below shows an example of information sent by the SMF instance to the RAN node.

TABLE 2

| | Value of PDU | |
|---|---|---|
| | Set Importance | |
| Mapping | field of GTP-U header | QoS Profile(s) |
| 1 | PDU Set Importance = 2 | QoS Profile, Alt-QoS Profile-1 |
| 2 | PDU Set Importance = 3 | QoS Profile, Alt-QoS Profile-1 |
| 3 | PDU Set Importance = 1 | Alt-QoS Profile-2 |

Also based on the one or more PCC rules for the downlink QoS flow, the SMF instance may also send to the UPF instance for the PDU session one or more control plane messages indicating the mapping of the plurality of application-level attributes (which may be indicated by a plurality of application-level header (e.g., RTP header) field values) to the plurality of GTP-U header field values (OPERATION 704).

Table 3 below shows an example of information sent by the SMF instance to the UPF instance.

TABLE 3

| | | Value for “PDU Set |
|---|---|---|
| | Media Attribute to | Importance” GTP-U header |
| Mapping | detect | field |
| 1 | I-Frame (video) | PDU Set Importance = 2 |
| 2 | P-Frame (video) | PDU Set Importance = 3 |
| 3 | Avatar | PDU Set Importance = 1 |

According to one example embodiment, the RTP header includes an extension indicating a PDU Set Importance value, and the UPF instance may not need mapping information from the SMF instance. The UPF instance may copy the PDU Set Importance value from the RTP header extension into the GTP-U header.

Also based on the one or more PCC rules, the SMF instance may send one or more control plane messages for the UE, indicating a plurality of QoS parameters indicating a plurality of QOS Profiles for an uplink QoS flow for the media application, and indicating a mapping of a plurality of application-level attributes (e.g., media types) to the plurality of UL QOS profiles indicated by the QoS parameters (OPERATION 706).

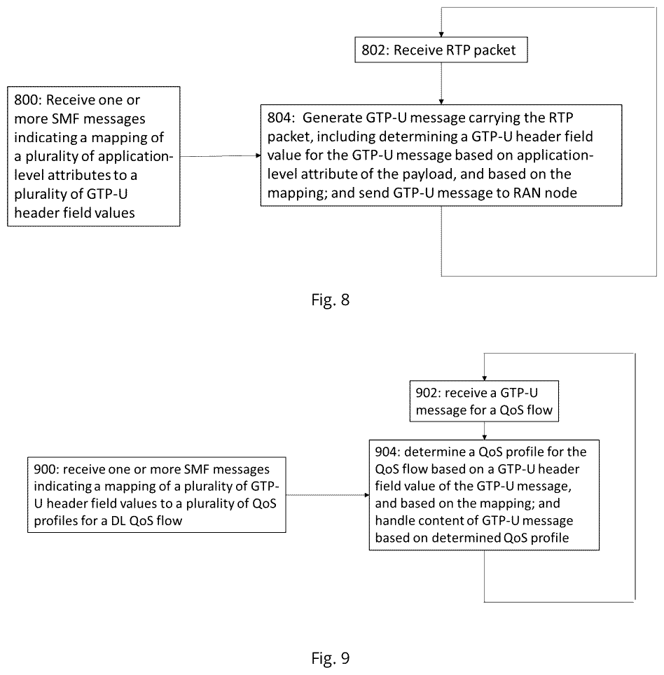

FIG. 8 shows a representation of operations by the UPF instance for the QoS flow for the media application, according to some example embodiments. The UPF instance receives the above-mentioned one or more SMF messages indicating the mapping of the plurality of application-level attributes (indicated by RTP packet (RTP header or payload) to the plurality of GTP-U header field values (OPERATION 800). In response to receiving from the data network an IP packet carrying a PDU belonging to a PDU Set (carrying an application-level unit of information) (OPERATION 802), the UPF instance generates a GTP-U message for carrying the IP packet, and sends the GTP-U message to the RAN node serving the UE (OPERATION 804). The generation of the GTP-U message by the UPF instance includes determining values for the header fields in the GTP-U header. One or more of the GTP-U header fields indicates that the carried PDU is part of a PDU set carrying the payload of one unit of information at the application-level. Another GTP-U header field (e.g., PDU Set Importance field) has a value based on an application-level attribute (e.g., media type) of the PDU payload (as indicated by information obtained from the RTP packet), and based on the above-mentioned mapping. One or more other fields of the GTP-U header (e.g., the PDU sequence number field indicating the position of the carried PDU within the PDU set) may have values different to other GTP-U message(s) carrying other PDU(s) belonging to the same PDU set.

FIG. 9 shows a representation of operations by the RAN node serving the UE for the PDU session, according to some example embodiments. The RAN node receives the above-mentioned one or more SMF messages indicating the mapping of the plurality of GTP-U header field values to the plurality of QoS profiles for the downlink QoS flow for the media application (OPERATION 900). In response to receiving a GTP-U message (OPERATION 902), the RAN node determines a QoS profile for the downlink QoS flow based on a GTP-U header field value of the GTP-U message, and the above-mentioned mapping; and handles the content of the GTP-U message based on the determined QoS profile (OPERATION 904).

In the event that a RAN node receives a GTP-U message with a different PDU Set Importance to a preceding GTP-U message, the switch to a different one of the QoS profiles for the QoS flow for the media application may be triggered immediately, or a slower trigger may be adopted to avoid excessively frequent QoS profile switches. A slower trigger may facilitate a simpler RAN implementation. For example, the RAN node may determine switching to another of the QoS profiles for the QoS flow for the media application based on an analysis of the value of the PDU Set Importance header field of GTP-U messages received over a period of time. In more detail, the RAN node may, for example, determine switching to another of the QoS profiles for the QoS flow for the media application based on an average of the value of the PDU Set Importance header field of GTP-U messages received over a period of time.

In some example embodiments, the RAN node may determine, in response to receiving a GTP-U message, one of the three QoS profiles (QOS Profile, Alt-QoS Profile-1, Alt-QoS Profile-2) for the downlink QoS flow according to the mapping shown in Table 2, based on the “PDU Set Importance” header field value of the GTP-U message. For example, if a user of the media application switches from a video call to an avatar call (that requires a data rate (e.g., 5 kbps) lower than that for the video call), the UPF instance detects the change in media type (based on the contents of the RTP packet (header and payload)), and switches to setting the PDU Set Importance field value of the GTP-U header to PDU Set Importance=1 (instead of PDU Set Importance=2 or PDU Set Importance=3 for a video call). In response to detecting a change in the PDU Set Importance field value of the GTP-U header, the RAN node switches to Alt-QoS Profile-2 for the downlink QoS flow for the media application. Alt-QoS Profile-2 may specify a guaranteed flow bit rate (GFBR) (e.g., 5 kbps) that is lower than the GFBR specified by the QoS Profile or Alt-QoS Profile-1 mapped to video streams via PDU Set Importance=2 or PDU Set Importance=3).

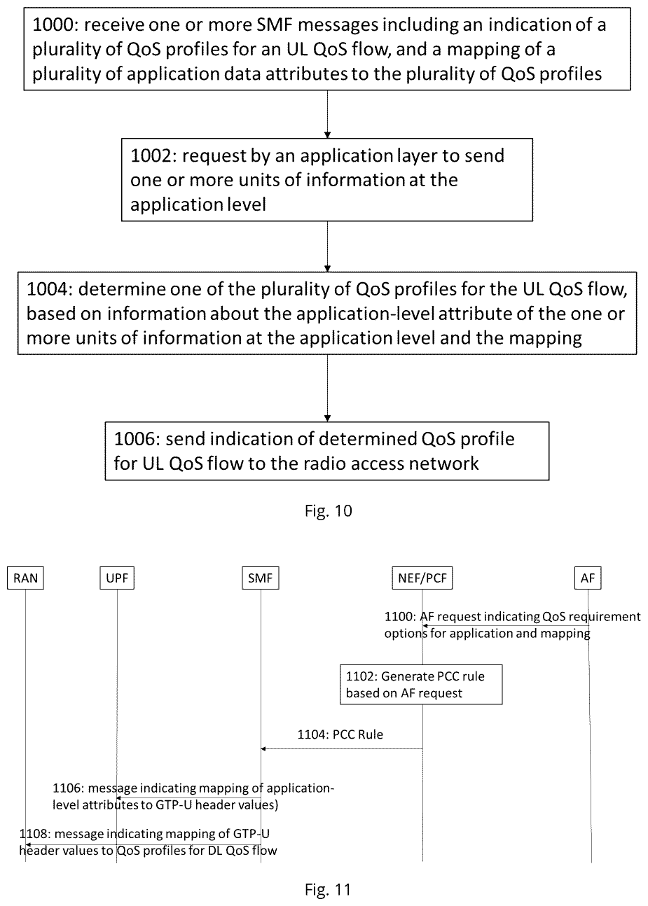

FIG. 10 shows a representation of uplink operations by the UE, according to some example embodiments. The UE receives one or more SMF control plane messages including an indication of a plurality of QoS profiles for an uplink QoS flow for the media application, and a mapping of a plurality of application-level attributes (e.g., media types) to the plurality of QOS profiles (OPERATION 1000). In response to a request by an application layer to send one or more units of information at the application-level (OPERATION 1002), a lower layer determines one of the plurality of QoS profiles based on an indication of an application-level attribute (e.g., media type) of the one or more application-level units of information, and based on the above-mentioned mapping (OPERATION 1004). The UE node sends an indication of the determined QoS profile to the RAN node, and the RAN node adopts the indicated QoS profile for the UL QoS flow (OPERATION 1006).

According to an alternative example, the UE sends information (e.g., meta-data) about an application-level attribute (e.g., media type) of the one or more units of information at the application-level to the RAN node serving the UE; and the RAN node determines a QoS profile for the uplink QoS flow for the media application. For example, the UE may include this meta-data in a message (e.g., buffer status report (BSR)) sent to the UE prior to UL transmission of PDUs to carry the one or more units of information at the application-level. According to another example, the UE includes this meta-data in a PDU header (e.g., Service Data Adaptation Protocol (SDAP)/Packet Data Convergence Protocol (PDCP) header). The meta-data included in the PDU header may trigger switching from one QoS profile for the uplink QoS flow to another QoS profile for the uplink QoS flow (based on mapping information received by the RAN node from the SMF instance), and application of the new QoS profile to the subsequent UL transmission of PDUs for the uplink QoS flow.

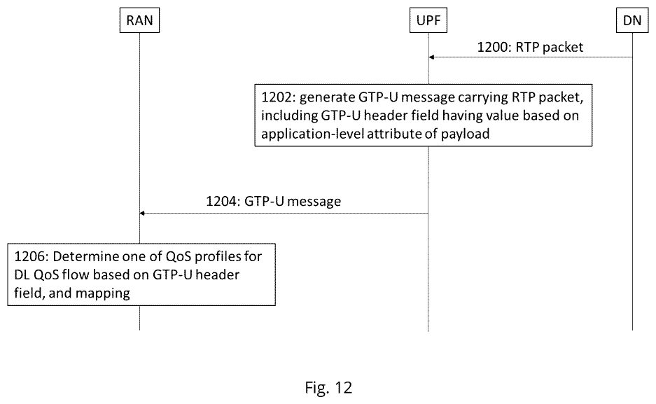

FIG. 11 shows a representation of messaging for PDU session modification according to some example embodiments; and FIG. 12 shows a representation of messaging for downlink transfer of RTP packets according to some example embodiments.

The AF for the multi-media application sends an AF request for PCF via NEF (OPERATION 1100). The AF request may take the form of a Nnef_AFSessionWithQoS Create/Update request. The request indicates a plurality of QoS requirement options for an application, a mapping between the QoS requirement options and a plurality of GTP-U header field values, and a mapping between the QoS requirement options and a plurality of application-level attributes (e.g., media types). Each QoS requirement option may comprise respective values for one or more QoS parameters such as one or more of PDU set error rate (PSER) and PDU Set Delay Budget (PSDB).

The PCF generates a PCC rule based on the AF request (OPERATION 1102). The PCC rule comprises: (i) a plurality of QoS parameter sets (QOS Parameter Set and one or more Alternative QoS Parameter Sets) for a downlink QoS flow for the media application, (ii) a mapping of GTP-U header field values to the plurality of QoS parameter sets (QOS Parameter Set and one or more Alternative QoS Parameter Sets); (iii) a mapping of a plurality of application-level attributes (e.g., media type) to the plurality of GTP-U header field values; and (iv) a mapping of the plurality of application-level attributes (e.g., media type) to a plurality of a QoS parameter sets (QOS Parameter Set and one or more Alternative QoS Parameter Sets) for an uplink QoS flow for the media application.

The PCF provides the PCC rule to the SMF instance for the PDU session (OPERATION 1104).

The SMF instance sends an N4 message to Enable UPF PDU Set Detection for the UPF instance for the PDU session (OPERATION 1106). The message indicates mapping of application-level attributes (e.g., media types) to GTP-U header values (OPERATION 1106). As described above, one example variation involves omitting this operation, and instead including in the RTP header (wherein the header may include a header extension) a PDU Importance Set field, whose value can be copied by the UPF instance into the GTP-U header of GTP-U message carrying the RTP packet.

The SMF instance also sends a message for the RAN node serving the UE for the PDU session, which message indicates mapping of a plurality of GTP-U header values to a plurality of QoS profiles for the downlink QoS flow for the media application (OPERATION 1108). The plurality of QoS profiles are based on the plurality of QoS parameter sets indicated by the PCC rule. The plurality of QoS profiles may be referred to as a QoS Profile and one or more Alternative (Alt) QoS Profiles.

In response to receiving from the data network an IP packet carrying a PDU belonging to a PDU set (carrying an application-level unit of information) (OPERATION 1200), the UPF instance for the PDU session generates a GTP-U message to carry the IP packet. The GTP-U message includes a GTP-U header indicating that the carried PDU belongs to a PDU set (OPERATION 1202). Generating the GTP-U message comprises determining a value for a GTP-U header field based on an application-level attribute (e.g., media type) of the carried PDU, which may be as indicated by the RTP header and payload of the RTP packet. The value of this GTP-U header field is the same for all GTP-U messages carrying the PDU set (application-level unit of information), but one or more other header fields (such as the PDU sequence number field indicating the position of the carried PDU within the PDU set) may differ between GTP-U messages carrying the PDU set.

The UPF instance sends the GTP-U messages to the RAN node serving the UE of the PDU session (OPERATION 1204).

The RAN node determines one of the QOS profiles for the downlink QoS flow for the media application based on the GTP-U header field value and the received mapping of a plurality of GTP-U header field values to a plurality of QoS profiles (OPERATION 1206). This determination may also be partly based on a congestion level in the RAN.

In relation to downlink communication, the above-described example embodiments involve mapping a plurality of PDU Importance Set header field values to a plurality of QoS profiles for the downlink QoS flow for the media application. One example variation involves alternatively or additionally mapping a plurality of values of another GTP-U header field value (e.g., PDU set size) to a plurality of QoS profiles for the downlink QoS flow for the media application. For example, a QoS profile allowing a relatively large PSDB and/or a relatively larger maximum data burst volume (MDBV) may be mapped to relatively large PDU sets, and another QoS profile allowing a smaller PSDB and/or smaller MDBV may be mapped to smaller PDU sets.

Furthermore, as mentioned above, the determination of one of the QoS profiles for the QoS flow for the media application may be additionally based on congestion status in the RAN (as indicated by e.g., rate of data traffic and/or resource availability).

The above-described techniques may, for example, facilitate better QoS determinations for e.g. a conversational communication involving one or more changes in media type during the communication, such as a change between video and avatar media.

It is noted that whilst some example embodiments have been described in relation to 5GS, similar concepts can be applied in relation to other mobile communication systems (such as 4G, 6G, 7G, etc., and/or in other wireless or wired communication networks). Therefore, although certain example embodiments were described above by way of non-limiting and illustrative example with reference to certain example architectures for wireless networks, technologies and standards, example embodiments may be applied to any other suitable forms of communication systems than those illustrated and described herein.

It is also noted herein that while the above describes various example embodiments, there are several variations and modifications which may be made without departing from the scope of the subject disclosure.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. As used herein, the expression “and/or” includes any and all combinations of one or more of the listed terms.

In general, the various example embodiments may be implemented in hardware or special purpose circuitry, software, logic or any combination thereof. Some example embodiments of the subject disclosure may be implemented in hardware, while other aspects may be implemented in firmware or software which may be executed by a controller, microprocessor or other computing device, although the disclosure is not limited thereto. While various example embodiments of the subject disclosure may be illustrated and described as block diagrams, flow charts, or using some other pictorial representation, it is well understood that these blocks, apparatus, systems, techniques or methods described herein may be implemented in, as non-limiting and illustrative examples, hardware, software, firmware, special purpose circuits or logic, general purpose hardware or controller or other computing devices, or some combination thereof.

As used herein, the term “circuitry” may refer to one or more or all of the following example embodiments:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The various example embodiments of this subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out any of the example embodiments (or some combination thereof). The one or more computer-executable components may be at least one software code or portions of it.

Further, in this regard it should be noted that any blocks of the logic flow as in the FIGURES may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (e.g., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting and illustrative examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various example embodiments of the subject disclosure is set out by the independent claims. The example embodiments and aspects, features, etc. thereof, if any, described herein that do not fall under the scope of the independent claims are to be interpreted as examples useful for understanding the various example embodiments of the subject disclosure.

The subject disclosure has provided, by way of non-limiting and illustrative examples, a full and informative description of the various example embodiments herein. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the claims. Indeed, there is a further example embodiment comprising a combination of one or more example embodiments with any of the other example embodiments described herein.

1. A radio access network node, comprising:
at least one processor; and
at least one memory storing instructions which, when executed by the at least one processor, cause the radio access network node at least to perform:
receiving one or more control plane messages indicating a plurality of quality-of-service profiles for a quality-of-service flow for a logical connection between a user equipment and a data network via a radio access network;
receiving user plane messages for the quality-of-service flow at the radio access network node, wherein an individual user plane message comprises a header comprising at least a first field; and
determining one of the plurality of quality-of-service profiles to adopt for the quality-of-service flow based on the first field and an indication in the one or more control plane messages of a mapping of the plurality of quality-of service profiles to a plurality of values for the first field.

2. The radio access network node according to claim 1, wherein the determining comprises determining one of the plurality of quality-of-service profiles to adopt for handling content of an individual user plane message for the quality-of-service flow based on the first field of the individual user plane message.

3. The radio access network node according to claim 1, wherein the determining comprises determining one of the plurality of quality-of-service profiles to use for the quality-of-service flow based on an average value of the first field over a plurality of the user plane messages.

4. A user equipment, comprising:
at least one processor; and
at least one memory storing instructions which, when executed by the at least one processor, cause the user equipment at least to perform:
receiving one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles;
determining one of the plurality of quality-of-service profiles to adopt for the uplink quality-of-service flow, based on one or more application-level attributes of one or more individual application-level units of information for sending to the data network via the radio access network, and the mapping; and
sending an indication of the determined quality-of-service profile for the uplink quality-of-service flow to the radio access network.

5. The user equipment according to claim 4, wherein the determining comprises determining one of the plurality of quality-of-service profiles to adopt for handling content of an individual user plane message for the quality-of-service flow based on the first field of the individual user plane message.

6. The user equipment according to claim 4, wherein the determining comprises determining one of the plurality of quality-of-service profiles to use for the quality-of-service flow based on an average value of the first field over a plurality of the user plane messages.

7. A method, comprising:
receiving at a user equipment one or more control plane messages indicating a plurality of quality-of-service profiles for an uplink quality-of-service flow for a logical connection between the user equipment and a data network via a radio access network of a mobile communication system, and a mapping of a plurality of application-level attributes to the plurality of quality-of-service profiles;
determining at the user equipment one of the plurality of quality-of-service profiles to adopt for the uplink quality-of-service flow, based on one or more application-level attributes of one or more individual application-level units of information for sending to the data network via the radio access network, and the mapping; and
sending an indication of the determined quality-of-service profile for the uplink quality-of-service flow to the radio access network.

8. The method according to claim 7, wherein the determining comprises determining one of the plurality of quality-of-service profiles to adopt for handling content of an individual user plane message for the quality-of-service flow based on the first field of the individual user plane message.

9. The method according to claim 7, wherein the determining comprises determining one of the plurality of quality-of-service profiles to use for the quality-of-service flow based on an average value of the first field over a plurality of the user plane messages.
